(19) United States
(12) Patent Application Publication
(10) Pub. No.: US 2008/0202388 A1
(43) Pub. Date: Aug. 28, 2008

(54) Stain free hydraulic binder, mortar and concrete

(75) Inventors: Lionel Raynaud, Corbelin (FR); Lorris Amathieu, Laurent De Mure (FR)

Correspondence Address: YOUNG & THOMPSON, 209 Madison Street, Suite 500, ALEXANDRIA, VA, 22314, US

(73) Assignee: KERNEOS, NEUILLY-SUR-SEINE (FR)

(21) Appl. No.: 11/710,964

(22) Filed: Feb. 27, 2007

(51) Int. Cl. C04B 7/36; C04B 28/06; C04B 7/32

(52) U.S. Cl. 106/695

(57) ABSTRACT

Process for reducing the occurrence an/or intensity of staining, after setting, of mortars and concretes.

The process consists in reducing the occurrence an/or intensity of staining, after setting, of mortars and concretes comprising at least one Portland cement and as a setting accelerator, at least one high alumina cement, which consists in suppressing or reducing the amount of C4AF from the Portland cement, free to move in the pore solution

### FIELD OF THE INVENTION

The present invention relates to a process for reducing the occurrence and/or intensity of staining, after setting, of mortars and concretes comprising a hydraulic binder containing cementitious components, said cementitious components including, as a setting accelerator, at least one high alumina cement.

### BACKGROUND OF THE INVENTION

Mortars and concretes comprising a hydraulic binder containing a Portland cement or a mixture of Portland cements and which include, as a setting accelerator, a high alumina cement (HAC), may exhibit, after setting a high staining phenomenon. This staining phenomenon results in the apparition of highly visible yellow to dark brown or black staining at the surface of the set mortars or concretes.

More particularly, this phenomenon occurs on cement accelerated boards where we have a hydraulic binder containing cementitious components like Portland Cement (PC) and high alumina cement (HAC), the latter having as an example, a content of around 10% by weight of the total binder.

Thus, there is a need to provide a process for reducing the occurrence and/or intensity of staining, preferably suppressing the occurrence of staining, after setting, in mortars and concretes accelerated with high alumina cement (HAC).

Literature survey and experiments that were conducted by us tend to indicate that the staining phenomenon is due to iron. Most probably, the occurrence of staining pertains to the overall iron content in the cementitious mix.

The latter is directly connected to the amount of iron species that can be released in the pore solution.

### SUMMARY OF THE INVENTION

Our laboratory tests showed surprisingly that the occurrence or intensity of staining is not linked to the total content of iron of the total weight of the hydraulic binder, HAC having a relatively high level of iron content, but rather linked to the iron of the Portland Cement (PC) mainly.

We found that during the hydration process, the anhydrous C4AF (with C=CaCO3, A=Al2O3, and F=Fe2O3) from the Portland Cement is the main source of staining and not the iron from the HAC. More particularly the free C4AF which hydrates in the pore solution is the main source of staining. Therefore all means that can either lower the amount of C4AF from the Portland Cement or block this C4AF during the hydration process, for instance by encapsulating or coating C4AF like by increasing the amount of ettringite formation, could be a solution to the problem.

The trigger of all the staining process seems to be the acceleration mechanism of PC by HAC itself. HAC reacts with calcium and alkali sulfates from the Portland Cement to form some ettringite. Hence, no (or not enough) sulfate is left available to coat the aluminous phases of the PC, like C3A and C4AF, with a shell of dense ettringite. Therefore, a flash set occurs which apparently strongly participates to the early set. As a side effect, iron from unprotected C4AF is free to move into the pore solution.

We believe that staining occurs from this mechanism
1/the extensive dissolution of C4AF phases of PC, what brings iron in the pore solution,
2/the transport of iron in solution or suspension due to water movement from the core of the material to the surface (driving forces: water evaporation, segregation, . . . ),
3/the formation of ferric oxides at the mortar—air interface.

It has not been possible to prevent the formation of ferric oxides (step 3) by adding an anti-oxidant or a reducer to the mix.

Beside the overall iron content of the mortar, some physical parameters proved out to be malevolent: cements with high Blaine Surface Area values (BSA fineness), mortars with a high porosity and/or highly connected pores (e.g. high Water/Binder=W/B, ratios).

Some experiments were conducted to hinder the diffusion of iron species to the surface (step 2): organic ligands that form insoluble complexes with iron were added, a strong oxidant was added to turn iron II into iron III which precipitates as ferric hydroxides (Fe(OH)3). None of them produced improvements.

Yet, some improvement was observed by decreasing W/B of the reference system. In this case a lower porosity is expected, due to a lower water content and a better particle size distribution. Hence controlling step 2 may improve the staining problem to some extent; however, this does not seem to be a powerful enough lever to suppress it.

In conclusion the above problem of suppressing or reducing the occurrence of staining of mortars and concretes comprising a hydraulic binder and at least one granulate, said hydraulic binder comprising at least one Portland cement (CP) and, as a setting accelerator, at least one high alumina-cement (HAC), is solved, by a process consisting in suppressing or reducing the amount of C4AF from the Portland cement free to move in the pore solution.

### BRIEF DESCRIPTION OF THE DRAWINGS

FIG. 1 shows photographs of test samples made with OPCs according to a first embodiment of the invention and OPCs outside the scope of the first embodiment;

FIG. 2 shows photographs of test samples with varying amounts of W/B ratios ; and

FIG. 3 shows photographs of test samples according to a second embodiment of the invention.

### DETAILED DESCRIPTION OF THE INVENTION

According to a first embodiment of the invention, reducing the occurrence and/or intensity of staining, preferably suppressing the occurrence of staining after setting, of mortars and concretes comprising a hydraulic binder and at least one granulate, said hydraulic binder comprising at least one Portland cement (CP) and, as a setting accelerator, at least one high alumina-cement (HAC), is achieved by selecting said at least one Portland cement amongst Portland cements having an iron oxide content of no more than 1% by weight based on the total weight of the Portland cement.

In the present invention a “hydraulic binder” means a mineral composition of finely ground materials which upon water addition of an appropriate quantity of water forms a binding paste or slurry capable of hardening in air as well as under water and binding together the granulates;

The hydraulic binder usually comprises one or more materials selected from clinkers, cements, slags, fly ashes and pozzolanic materials. Typically, the materials of the hydraulic binder have a particle size≦200 μm.

In the present invention, a “granulate” means an inert granular material which, when agglomerated by a hydraulic binder constitutes the skeleton of the mortar or concrete (inert means that the granulate does not react with the hydraulic binder and participates to the mortar or concrete mechanical resistance only due to the compacity it imparts to the mortar or concrete).

By “additive” there is meant any organic or mineral material which, when incorporated to the mortar or cement during mixing, impart intended modifications to the usual properties or behaviour of the mortars and cements. They are usually added at low rates, typically 5% by weight or less based on the total weight of the hydraulic binder. Examples of such additives are organic setting accelerators and retarders, water reducing agents, air entraining agents, plasticizers and superplasticizers, surfactants and cure agents.

By “high alumina cement” there is meant a cement which comprises at least 33% by weight of calcium aluminates and/or calcium sulfoaluminates ($=SO3) based on the total weight of said high alumina cement. Typically, calcium aluminates and calcium sulfo-aluminates will be present in the form of mineralogical phases CA, C3A, C12A7, C2AS, C4AF, C4A3$, predominantly C4A3$ for calcium sulfoaluminates.

The above first embodiment of the invention comprises choosing PC with low content of C4AF.

As said above it is also possible to use PC with higher level of 10 C4AF content and still reducing the occurrence of staining by modifying the parameters of hydration (step 1 as said above, notably by encapsulating or coating C4AF of Portland cement by the formation of ettringite).

Counteracting step 1 is a very harsh issue since it is strongly related to the acceleration mechanism. Experiments that were done can be divided in two types
1/addition of rapidly soluble calcium to the mix in order to retrieve the formation of ettringite around C3A and C4AF and prevent the dissolution from the latter. At the same time, the mixes were supplemented with rapid sulfates in order to substitute the flash set with an ettringite set and then recover short setting times.
2/addition of slow CaSO4 (Anhydrite) to allow flash set to occur; the slow dissolution of Anhydrite was expected to eventually block C4AF with a layer of ettringite.

Way 1 produced a clear improvement of the staining, may be a complete improvement, but it has not been possible to recover short setting times.

Way 2 gave the best results with, in most of the cases, no staining at all at 2 days. The setting times could be quite short depending on the addition process (benevolent effect of a delayed addition) or on the addition of accelerators (sodium carbonate and tartaric acid).

Therefore, in a second embodiment of the present invention, there is provided a process for reducing the occurrence and/or intensity of staining, preferably suppressing the occurrence of staining after setting, of mortars and concretes comprising a hydraulic binder and at least one granulate, said hydraulic binder comprising at least one Portland cement (CP) and, as a setting accelerator, at least one high alumina-cement (HAC), which comprises adding, as a staining reducing agent, to 100 parts by weight of hydraulic binder, 0.5 to 5 parts by weight, preferably 1 to 3 parts by weight of a rapidly soluble calcium compound, in particular rapidly soluble calcium salts.

By “rapidly soluble calcium compound” there is meant a calcium compound, in particular a calcium salt which is more rapidly soluble in water, in the same conditions, than anhydrous CaSO₄.

In a third embodiment of the present invention, there is provided a process for reducing the occurrence and/or intensity of staining, preferably suppressing the occurrence of staining after selling, of mortars and concretes comprising a hydraulic binder and at least one granulate, said hydraulic binder comprising at least one Portland cement (CP) and, as a setting accelerator, at least one high alumina-cement (HAC), which comprises adding as a staining reducing agent, to 100 parts by weight of hydraulic binder, 0.5 to 20 parts by weight, preferably 5 to 15 parts by weight of anhydrite, and optionally 0.5 to 10 parts by weight, preferably 1 to 5 parts by weight of slaked lime.

Addition of retarders such as tartaric acid and accelerators such as sodium carbonate is also possible in this third embodiment.

Preferably, the high alumina cement is selected amongst high alumina cements having a Blaine surface area ranging from 2000 to 5000, preferably 2500 to 4000. The hydraulic binder of the invention usually contains 25% to 99% by weight, preferably 35% to 95% by weight and more preferably 45% to 95% by weight of Portland cements base on the total weight of the hydraulic binder.

The hydraulic binder also typically contains 1% to 25% by weight, preferably 5% to 25% by weight and more preferably 5% to 15% by weight of high alumina cement. Of course the hydraulic binder can consist only of Portland cements and high alumina cements.

The total iron content (Fe₂O₃) of the hydraulic binder according to the invention is generally at least 1.5% by weight based on the total weight of the hydraulic binder.

Unless otherwise stated, all percentages and parts are by weight.

Although some of the added staining reducing agents useful in the present invention, would satisfy the given definition for the hydraudic binder, for example anhydrite and slaked lime, there are not considered as part of the binder, but as added components whether they are added to the hydraulic binder, the mortars or the concretes.

### I-First Embodiment

I.1—All mortars were made using the base composition of Table 1 below and in conformity with European standard EN 196-1.

TABLE 1

| | Component | Mass (g) |
|---|---|---|
| Hydraulic binder | OPC | 1093.5 |
| | HAC | 121.5 |
| Aggregates | EN Sand | 1350 |
| Water | Tap water | 486 |
| Water/binder ratio (W/B) | | 0.40 |

OPC = Portland cement
HAC = High alumina cement
EN sand = AFNOR Sand conforming to the requirements of European standard EN 196-1.

Samples are casts having a trunconical shape of:
Height 20 cm
Top diameter 10 cm
Base diameter 5 cm

### I.2-Rating of the Staining Results

The results have been rated according to the mark-aspect equivalence in table 2

TABLE 2

| | no stain | Yellow | Light-brown | Dark-brown |
|---|---|---|---|---|
| Colour | 0 | 1 | 2 | 3 |
| | no stain | light | pronounced | |
| intensity | 0 | 1 | 2 | |

The rating of the sample was done by visual inspection according to Table 2, using the the expression (Colour, intensity). It was evaluated after 2 days (1 day at 23° C.-50% relative humidity in the lab, and 1 day of cure at 48° C.-90% relative humidity) and after 7 days of additional cure (48° C.-90% relative humidity). Generally, the intensity of the stains increased between 2 days and 7 days. Staining did not proceed further when the samples were removed from the climatic chamber after 7 days.

### I.3-Influence of the Type of Portland Cement

Four OPC with different iron contents were tested. These iron content are measured by X-Ray fluorescence and are expressed as Fe₂O₃. Those PCs are listed in table 3 below together with their C4AF and overall iron content. Also the total iron content in the binder (121.5 g HAC at 17.2% Fe2O3+1093.5 g PC) has been calculated as well as the percentage of iron coming from the HAC. All PCs were used at BSA 3500 cm²/g.

TABLE 3

| | | | | Fe2O3 | |
|---|---|---|---|---|---|
| | Fe2O3 | C4AF | Total Fe2O3 | from | Fe2O3 |
| | in PC (%) | (%) | in Binder (%) | PC (%) | from HAC (%) |
| VAZ | 4.61 | 14 | 5.87 | 4.15 | 1.72 |
| LHVR | 4.23 | | 5.53 | 3.81 | 1.72 |
| HTS | 1.86 | 6 | 3.19 | 1.47 | 1.72 |
| SPBL | 0.23 | 1 | 1.93 | 0.21 | 1.72 |

VAZ = Portland cement Val d'Azergues
LHVR = Portland cement Le Havre
HTS = Portland cement Le Teil
SPBL = Portland cement Le Teil Super Blanc
HAC = Ciment Fondu (CF), from Kerneos ground at a SBA of 5000 cm2/g (CF 5000)

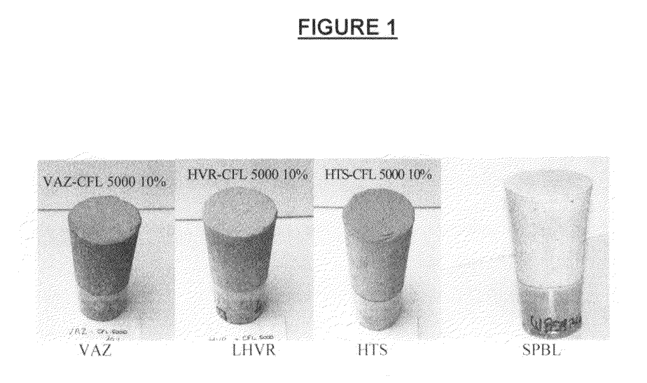

It appears that, despite the higher content in iron of HAC's, the PC is the main source of iron in the mix when iron-rich PCs are used.
The results show that there is a sharp effect of the OPC's iron content. Mixes of CF and Val'd'Azergues OPC show intense and dark stains on both the top surface and the uncovered side-walls of the sample. Those comments also apply to OPC from Le Havre which contains a lot of iron. Conversely, mixes of CF-5000 and HTS Le Teil display no stains on the sides and very weak, light-colored stains on the top (where the surface is very rough). However, inspection of the samples after 7 days shows that stains tend to appear on the sides. The intensity of the stains seems to grow with time. There is no staining with mixes of CF-5000 and Le Teil Superblanc. Photographs of the test samples are shown in FIG. 1.
Table 4 displays the setting times of the mortars made with the different OPCs and the staining levels.

TABLE 4

| BS (min.) | ES (min.) | staining |
|---|---|---|
| 30 | 40 | (3, 2) |
| 136 | 186 | (3, 2) |
| 15 | 25 | (1, 1) |
| 22 | 28 | (0, 0) |

BS = Beginning of setting
ES = End of setting

### I.4-Impact of the Water/Binder Ratio

Base composition of Table 1 above have been used except for water content.

The Water/Binder ratio has been changed in order to vary the overall porosity of the samples. Since iron transport (toward the surfaces) is suspected to cause or at least to enhance the staining phenomenon, an improvement was expected from a reduction in porosity. Obviously, the consistency of the mortar also changed with the W/B ratio. Table 6 below presents the various W/B ratios that were tested.

TABLE 5

| W/B | Water (g) | BS (min.) | ES (min.) | Consistency |
|---|---|---|---|---|
| 0.3 | 365 | 22 | 27 | Viscous |
| 0.35 | 425 | 32 | 52 | Normal |
| 0.4 | 486 | 37 | 57 | Normal |
| 0.45 | 547 | 42 | 72 | Liquid |
| 0.5 | 607 | 47 | 112 | Very liquid |

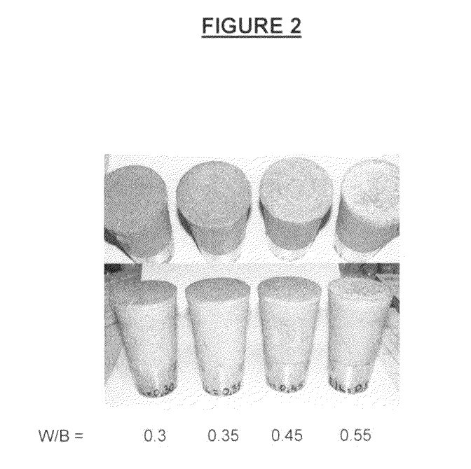

FIG. 2 are photographs of those samples showing that the staining increases with the W/B ratio, especially on the top of the sample. Probably some bleeding occurs at high W/B ratios, hence worsening the problem. There is also a gradual increase of the brownish intensity on the sides with increasing the W/B ratio.

### II. Second Embodiment

In this embodiment, the preferred calcium salt is CaCl₂, although other rapidly soluble calcium salts can be used. Examples of such salts are calcium bromide, calcium nitrate, calcium nitrite, calcium formiate, calcium acetate, calcium hydroxide and calcium carbonate.

Typically the amount of rapidly soluble calcium compound added to the mortar or concrete ranges from 0.1 to 5 parts by weight, preferably from 0.5 to 5 parts by weight, more preferably 1 to 3 parts by weight, per 100 parts by weight of the hydraulic binder.

The first tests were conducted with CaCl₂. Subsequently, other calcium salts were tested.

### II.1-Addition of Calcium Chloride

Calcium chloride was added to the various mortars of composition as set forth in first embodiment, but with VAZ Portland cement.

Three HAC cement were tested. Their characteristics are given in Table 6 Percentages of CaCl₂ given in Tables 7 are given in weight based on the total weight of the hydraulic binder.

TABLE 6

| | HAC1 | HAC2 | HAC3 |
|---|---|---|---|
| Main phase | CA (~50%) | CA (~65%) | C₁₂A₇ (~55%)% |
| BSA (cm2/g) | 5000 | 4000 | 4830 |
| Fe2O3 | 14.4 | 2.0 | 10.3 |

TABLE 7

| | | BS/ES | |
|---|---|---|---|
| Binder | CaCl₂ addition (%) | (min.) | Staining |
| VAZ + HAC1 | 0 | 30/40 | (3, 2) |
| VAZ + HAC1 | 1 | 142/197 | (3, 1) |
| VAZ + HAC1 | 2 | 102/132 | (2, 1) |
| VAZ + HAC3 | 0 | 172/292 | (2, 2) |
| VAZ + HAC3 | 2 | 182/222 | (2, 1) |
| VAZ + HAC2 | 0 | 27/37 | (3, 2) |
| VAZ + HAC2 | 1 | 147/202 | (3, 1) |

A 1% addition of CaCl₂ to mixes containing HAC1 or HAC2 significantly decreased the intensity of the stains. It also improved the mix containing HAC3 to some extent.

An increase in the amount of calcium chloride further improved the results: all the mixes that were tested with a 2% addition of Calcium Chloride did not exhibit staining at 2 days. However, some discoloration appeared after 7 days of cure.

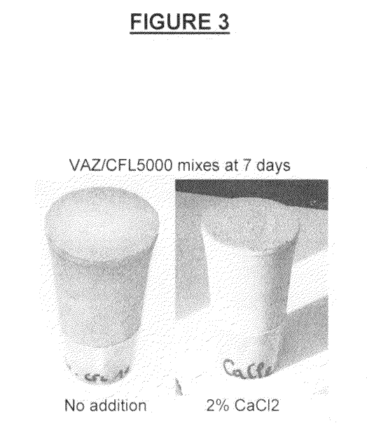

FIG. 3 shows the impact of a 2% CaCl2 addition on the staining of VAZ/HAC1 mixes.

### II.2-Addition of Other Calcium Salts

Other calcium salts have been tested. All of them were chosen because of their high solubility in water.

TABLE 8

| | | | BS/ES | | BS/ES | |
|---|---|---|---|---|---|---|
| Calcium salt | HAC1 | | (min.) | HAC2 | (min.) | Staining |
| Calcium | 44 | g | | | | (2, 1) |
| Bromide | | | | | | |
| Calcium Nitrate | 24 | g | 132/193 | | | (2, 1) |
| Calcium Nitrite | | | | 6 g | 52/102 | (2, 1) |
| Calcium | 6 | g | 158/193 | 6 g | 58/73 | (2, 1) |
| Formiate | | | | | | |
| Calcium | 38.4 | g | >202 | | | (2, 1) |
| Acetate | | | | | | |
| Calcium | | | | 6 g | 26/56 | (2, 1) |
| Hydroxide | | | | | | |

NB: The mass of calcium salts in table 8 is the one added to the composition in table 1.

Soluble salts which were added to the HAC1+VAZ systems roughly produced the same effect on staining than CaCl₂.

Some improvements in staining were observed upon the addition of Calcium salts to HAC2+VAZ systems.

### III-Third Embodiment

In this third embodiment, although anhydrite can be added alone, it is preferably added with slaked lime.

Preferably, there is added the same amounts of anhydrite than the amount of HAC present in the hydraulic binder.

However, such additions have a tendency to slow the setting of the mortars and concretes.

It has been found that by adding sodium carbonate and optionally tartaric acid, preferably both, reduced setting times can be obtained.

Usually, sodium carbonate is added in the range of 0.25 to 3 parts by weight, preferably 0.5 to 2.5 parts by weight for 100 parts by weight of the hydraulic binder, and tartaric acid is added in the range of 0 to 1 part by weight, preferably 0.025 to 1 part by weight for 100 parts by weight of the hydraulic binder.

Tables 9, 10, 11 and 12 are compositions of mortars according to the third embodiment.

### Addition of Anhydrite and Slaked Lime

TABLE 9
Immediate addition of HAC1 + Anhydrite + lime

| Components | Mass added (g) |
|---|---|
| VAZ | 1093.5 |
| HAC1 | 121.5 |
| Anhydrite ICI | 214 |
| Slaked lime | 62.3 |
| EN Afnor Sand | 1350 |
| Water | 486 |
| W/B | 0.325 |
| BS (min.) | 102 |
| ES (min.) | 122 |

TABLE 10
Delayed addition of HAC1 + Anhydrite + lime

| Components | Mass added (g) |
|---|---|
| VAZ | 1093.5 |
| EN Afnor Sand | 1350 |
| Water | 486 |

Delayed addition at 2′30″

| | |
|---|---|
| Anhydrite ICI | 214 |
| Slaked lime | 62.3 |
| HAC1 | 121.5 |
| W/B | 0.325 |
| BS (min.) | 77 |
| ES (min.) | 127 |

### Addition of Anhydrite Alone

TABLE 11
Immediate addition of Anhydrite

| Components | Mass added (g) |
|---|---|
| VAZ | 1093.5 |
| HAC1 | 121.5 |
| Anhydrite ICI | 59 |
| EN Afnor Sand | 1350 |
| Water | 486 |
| W/B | 0.38 |
| BS (min.) | 107 |
| ES (min.) | 177 |

TABLE 12
Delayed addition of Anhydrite

| Components | Mass added (g) |
|---|---|
| VAZ | 1093.5 |
| EN Afnor Sand | 1350 |
| Water | 486 |

Delayed addition at 2′30″

| | |
|---|---|
| Anhydrite ICI | 214 |
| HAC1 | 121.5 |
| W/B | 0.38 |
| BS (min.) | 37 |
| ES (min.) | 62 |

There is no difference between the immediate and the delayed addition. However, the presence of lime is benevolent to the reduction of staining. The samples containing additions of anhydrite and lime, displays no staining at 2 days (0,0) whereas those containing anhydrite exhibit a pale yellowish color (1,1).

### Recovery of the Setting Time by Addition of Sodium Carbonate and Tartaric Acid

Sodium carbonate and tartaric acid were added in order to shorten the setting times. Setting times were indeed shortened as shown in table 13 and no stain was observed.

TABLE 13

| | | | | |
|---|---|---|---|---|
| HAC1 (g) | 121.5 | 121.5 | 60.3 | 121.5 |
| Anhydrite ICI (g) | 214 | 214 | 9.72 | 214 |
| Lime (g) | 62.3 | 62.3 | 0 | 62.3 |
| Sodium Carbonate (g) | 6.07 | 12.15 | 21.3 | 21.26 |
| Tartaric acid (g) | 0 | 0 | 0.6 | 0.6 |
| EN Afnor Sand (g) | 1350 | 1350 | 1350 | 1350 |
| Water (g) | 486 | 486 | 486 | 492 |
| W/B | 0.325 | 0.325 | 0.325 | 0.325 |
| BS (min.) | 112 | 92 | 24 | 22 |
| ES (min. | 152 | 132 | 84 | |
| Staining | 0 | 0 | 0 | 0 |

### Minimizing the Amount of Anhydrite and Lime in the Mixture

The amount of anhydrite+lime added was reduced to determine the threshold value for staining. The objective here is to minimize the ratio (anhydrite+lime/HAC1) while keeping the samples free of stains.

Table 14 shows the compositions that were tested.

TABLE 14

| | | |
|---|---|---|
| HAC1 (g) | 121.5 | 121.5 |
| Anhydrite ICI (g) | 121.5 | 60.8 |
| Lime (g) | 35.3 | 17.7 |
| Sodium Carbonate (g) | 0 | 12.15 |
| Tartaric acid (g) | 0 | 0 |
| EN Afnor Sand (g) | 1350 | 1350 |
| Water (g) | 445.8 | 420.4 |
| W/B | 0.325 | 0.325 |
| BS (min.) | 97 | 102 |
| ES (min. | 142 | 142 |
| Staining | 0 | 3.1 |

Good results are obtained with same proportions of anhydrite and HAC1.

1. A process for reducing the occurrence and/or intensity of staining, preferably suppressing the occurrence of staining after setting, of mortars and concretes comprising a hydraulic binder and at least one Portland cement (PC) and, as a setting accelerator, at least one high alumina-cement (HAC), which consists in suppressing or reducing the amount of C4AF from the Portland cement free to move in the pore solution.

2. The process of claim 1, wherein suppressing or reducing the amount of C4AF free to move in the pore solution comprises selecting said at least one Portland cement amongst Portland cements having an iron oxide content of no more than 3% preferably no more than 2%, and even better no more than 1% by weight based on the total weight of the Portland cement.

3. The process of claim 1, wherein suppressing or reducing the amount of C4AF free to move in the pore solution comprises adding, as a staining reducing agent, to 100 parts by weight of hydraulic binder, 0.5 to 5 parts by weight, preferably 1 to 3 parts by weight of a rapidly soluble calcium compound.

4. The process of claims 3, wherein the rapidly soluble calcium compound salt is selected from calcium chloride calcium bromide, calcium nitrate, calcium nitrite, calcium formate, calcium acetate, calcium hydroxide and calcium carbonate and mixtures thereof, preferably calcium chloride.

5. The process of claim 1, wherein suppressing or reducing the amount of C4AF free to move in the pore solution comprises adding as a staining reducing agent, to 100 parts by weight of hydraulic binder, 0.5 to 20 parts by weight, preferably 5 to 15 parts by weight of anhydrite, and optionally 0.5 to 10 parts by weight, preferably 1 to 5 parts by weight of slaked lime.

6. The process of claim 5, wherein there is further added sodium carbonate and, optionally tartaric acid.

7. The process of claim 6, wherein sodium carbonate is added in the range of 0.25 to 3 parts by weight, preferably 0.5 to 2.5 parts by weight for 100 parts by weight of the hydraulic binder, and tartaric acid is added in the range of 0 to 1 part by weight, preferably 0.025 to 1 part by weight for 100 parts by weight of the hydraulic binder.

8. The process according to claim 1 wherein the hydraulic binder contains 25 to 99% by weight, preferably 35% to 95% by weight and preferably 45% to 95% by weight of Portland cements.

9. The process according to claim 1 wherein the hydraulic binder also contains 1% to 25% by weight, preferably 5% to 25% by weight and more preferably 5% to 15% by weight of high alumina-cement.
